(19) United States
(12) Patent Application Publication
(10) Pub. No.: US 2007/0093124 A1
(43) Pub. Date: Apr. 26, 2007

(54) Methods and structure for SAS expander optimization of SAS wide ports

(75) Inventors: Brian J. Varney, Colorado Springs, CO (US); David T. Uddenberg, Colorado Springs, CO (US); Mark Slutz, Colorado Springs, CO (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 11/254,849

(22) Filed: Oct. 20, 2005

(51) Int. Cl. H01R 12/24

(52) U.S. Cl. 439/499

(57) ABSTRACT

Methods and structures within a SAS expander for monitoring bandwidth utilization of a SAS wide port associated with the expander and for effecting reconfiguration of the wide port to improve SAS domain performance. In one aspect, a SAS expander may monitor utilization of a wide port of the expander. If the wide port is over-utilized, the expander may inform a SAS initiator of the need for one or more additional links to be configured in the wide port. If the wide port is under-utilized, the expander may reconfigure the wide port by disabling a link to reduce power consumption associated with that link. If the wide port is later over-utilized, a previously disabled link may be re-enabled by the expander to restore available bandwidth. Disabled links of a wide port may also be reported to a SAS initiator to be reconfigured by the initiator for use in another communication path.

### BACKGROUND OF THE INVENTION

1. Field of the Invention

The invention relates generally to serial attached SCSI (“SAS”) domains and more specifically to methods and structures enabling a SAS expander to optimize aspects of operation of SAS wide ports in the expander.

2. Discussion of Related Art

Small Computer Systems Interface (“SCSI”) is a set of American National Standards Institute (“ANSI”) standard electronic interface specification that allows, for example, computers to communicate with peripheral hardware. Common SCSI compatible peripheral devices may include: disk drives, tape drives, CD drives (“CD-ROM”, “CD-RW”, etc), DVD drives, printers and scanners. SCSI as originally created included both a command/response data structure specification and an interface and protocol standard for a parallel bus structure for attachment of devices. SCSI has evolved from exclusively parallel interfaces to include both parallel and serial interfaces. “SCSI” is now generally understood as referring either to the communication transport media (parallel bus structures and various serial transports) or to a plurality of primary commands common to most devices and command sets to meet the needs of specific device types as well as a variety of interface standards and protocols.

The collection of primary commands and other command sets may be used with SCSI parallel interfaces as well as with serial interfaces. The serial interface transport media standards that support SCSI command processing include: Fibre Channel, Serial Bus Protocol (used with the Institute of Electrical and Electronics Engineers 1394 FireWire physical protocol; “IEEE 1394”) and the Serial Storage Protocol (SSP).

SCSI interface transports and commands are also used to interconnect networks of storage devices with processing devices. For example, serial SCSI transport media and protocols such as Serial Attached SCSI (“SAS”) and Serial Advanced Technology Attachment (“SATA”) may be used in such networks. These applications are often referred to as storage networks. Those skilled in the art are familiar with SAS and SATA standards as well as other SCSI related specifications and standards. Information about such interfaces and commands is generally obtainable at the website http://www.t10.org.

Such SCSI storage networks are often used in large storage systems having a plurality of disk drives to store data for organizations and/or businesses. The network architecture allows storage devices to be physically dispersed in an enterprise while continuing to directly support SCSI commands. This architecture allows for distribution of the storage components in an enterprise without the need for added overhead in converting storage requests from SCSI commands into other network commands and then back into lower level SCSI storage related commands.

A SAS network typically comprises one or more SAS initiators coupled to one or more SAS targets often via one or more SAS expanders. In general, as is common in all SCSI communications, SAS initiators initiate communications with SAS targets. The expanders expand the number of ports of a SAS network domain used to interconnect SAS initiators and SAS targets (collectively referred to as SAS devices or SAS device controllers).

In general, a SAS initiator directs information to a SAS target device through ports of one or more SAS expanders in the SAS domain. A “port” in SAS terminology is a logical concept. A port may comprise one or more physical links in a SAS domain. Such physical links are often referred to as PHYs in the terminology of SAS domains. A port may use a single PHY or, if the port is configured as a wide port, may use multiple PHYs logically grouped to provide higher bandwidth.

SAS initiators are typically associated with general purpose processing capabilities useful to configure and manage aspects of a SAS domain. A SAS initiator in a SAS domain is typically responsible for configuring and/or detecting the presence of wide ports of SAS expanders. A SAS initiator may interact with an administrative user to define logical ports of one or more SAS expanders in the domain as wide ports based on the anticipated bandwidth requirements of devices in the domain. For example, where a particular path between one SAS initiator and a particular SAS target is expected to require additional communication bandwidth, the SAS initiator may initially configure that path to use a SAS wide port. Often the wide ports are pre-configured (e.g., “hard wired”) in a particular enterprise based on requirements perceived by the system designer. Thus, the SAS initiator may simply sense the pre-configured wide ports of a SAS domain during the SAS Discover process. In other applications, SAS wide ports may be dynamically defined by configuration features associated with a SAS initiator in the SAS domain. The physical link connections that comprise a wide port may be reconfigured through cabling or switching means. Thus a SAS initiator may actively configure the physical links of a SAS expander for use as a SAS wide port.

In any case, it is an ongoing problem to adjust the configuration as need or utilization change dynamically in a SAS domain. It is difficult for a SAS initiator to effectively, accurately, and continually monitor the performance and utilization of a wide port to determine if additional bandwidth may be required or if the wide port is presently being under-utilized and hence wasteful of resources in the SAS domain.

It is therefore evident from the above discussion that a need exists for improved solutions in a SAS domain to monitor performance of a SAS wide port to determine whether reconfiguration may be desired to improve performance or to better utilize SAS domain resources.

### SUMMARY OF THE INVENTION

The present invention solves the above and other problems, thereby advancing the state of the useful arts, by providing methods and structures associated with a SAS expander in a SAS domain for monitoring performance and/or utilization of a configured SAS wide port and to effect reconfiguration to better utilize the SAS wide port resources and/or to improve wide port performance. In one aspect, a SAS expander may monitor utilization of a wide port of the expander. If the wide port is over-utilized, the expander may inform a SAS initiator of the need for one or more additional links to be configured in the wide port. If the wide port is under-utilized, the expander may reconfigure the wide port by disabling a link to reduce power consumption associated with that link. If the wide port is later over-utilized, a previously disabled link may be re-enabled by the expander to restore available bandwidth. Disabled links of a wide port may also be reported to a SAS initiator to be reconfigured by the initiator for use in another communication path.

A first feature hereof therefore provide a method operable in a SAS domain for reconfiguring a SAS wide port of a SAS expander, the method comprising: monitoring performance of an operating wide port associated with the SAS expander; effecting reconfiguration of the operating wide port to improve performance thereof.

Another aspect hereof further provides that the step of monitoring further comprises monitoring bandwidth utilization, and that the step of effecting reconfiguration further comprises informing a SAS device coupled to the SAS expander of bandwidth over-utilization of the wide port to cause the SAS device to reconfigure the wide port to add one or more additional links to the wide port.

Another aspect hereof further provides that the SAS device is another SAS expander.

Another aspect hereof further provides that the SAS device is a SAS initiator.

Another aspect hereof further provides that the step of monitoring further comprises monitoring bandwidth utilization, and that the step of effecting reconfiguration further comprises disabling a link associated with the wide port in response to determining that the available bandwidth of the wide port is under-utilized.

Another aspect hereof further provides that the step of effecting reconfiguration further comprises re-enabling a previously disabled link associated with the wide port in response to determining that the available bandwidth of the wide port is over-utilized.

Another feature hereof provides a system comprising: a SAS device; and a SAS expander coupled to the SAS device wherein the SAS expander is coupled to the SAS device by a wide port and wherein the SAS expander further comprises: a performance monitor adapted to monitor performance of the wide port during operation thereof, and a reconfiguration controller coupled to the performance monitor adapted to effect reconfiguration of the wide port based upon monitored performance of the wide port.

Another aspect hereof further provides that the performance monitor is further adapted to monitor bandwidth utilization of the operating wide port.

Another aspect hereof further provides that the reconfiguration controller is adapted to inform the SAS device of a bandwidth over-utilization condition of the operating wide port as sensed by the performance monitor.

Another aspect hereof further provides that the reconfiguration controller is adapted to disable a link of the wide port in response to detection of a bandwidth under-utilization condition of the operating wide port sensed by the performance monitor.

Another aspect hereof further provides that the reconfiguration controller is further adapted to re-enable a previously disabled link of the wide port in response to detection of a bandwidth over-utilization condition of the operating wide port sensed by the performance monitor.

### BRIEF DESCRIPTION OF THE DRAWINGS

FIG. 1 is a block diagram of a SAS domain embodying features and aspects hereof for SAS device enhanced to monitor and reconfigure a wide port coupled to the device.

FIG. 2 is a flowchart describing a method in accordance with features and aspects hereof whereby a SAS device may monitor and reconfigure a wide port to improve performance and/or resource utilization.

FIG. 3 is a flowchart describing a method in accordance with features and aspects hereof whereby an enhanced SAS expander may monitor performance of a wide port configured therein and may reconfigure aspects of the wide port substantially independent of an associated SAS initiator.

### DETAILED DESCRIPTION OF THE DRAWINGS

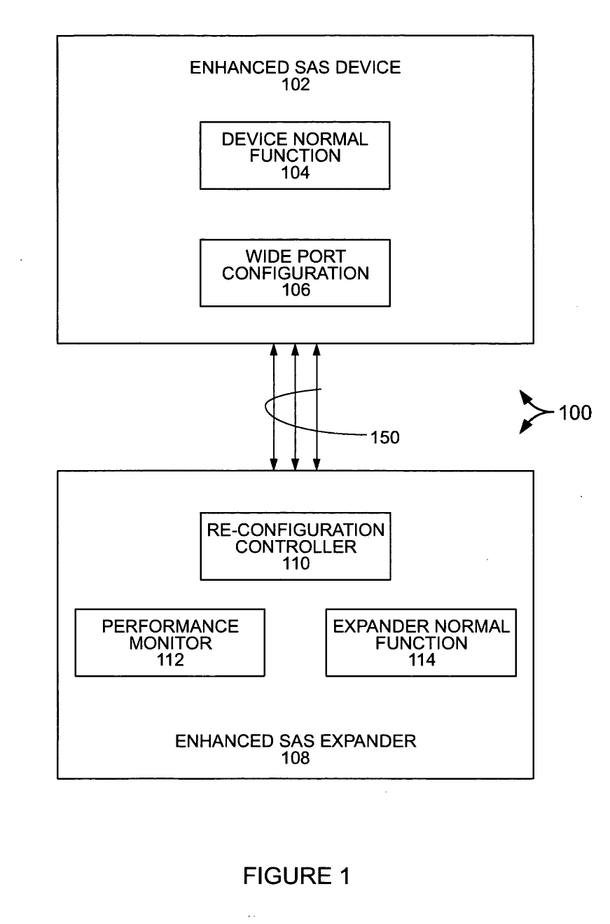

FIG. 1 is a block diagram showing a SAS domain 100 including a SAS device 102 and a SAS expander 108 enhanced in accordance with features and aspects hereof to enable automated monitoring and reconfiguration of a wide port 150 in the SAS domain 100. Enhanced SAS device 102 and enhanced SAS expander 108 may be coupled via wide port 150 comprised of multiple links.

SAS device 102 may be a SAS initiator or another SAS expander in the SAS domain. As generally known in the art, wide port 150 may be initially configured by SAS device 102 or may be pre-configured (e.g., hard wired) by a system designer to utilize a sufficient number of links configured as a single logical wide port as may be expected to be required for the particular communication application.

As is generally known in the art SAS device 102 may include device normal function element 104 for performing all normal operations of SAS device 102 to permit exchanges with other SAS devices in domain 100. SAS expander 108 may include expander normal function element 114 representing processing capabilities within expander 108 for performing normal communication processing of the expander. Wide port configuration element 106 of device 102 may provide functionality for determining the initial configuration of wide port 150 (e.g., a SAS Discovery process) as well as reconfiguration of a wide port dynamically reconfigurable at the direction of an administrative user or in response to other input. In accordance with features and aspects hereof, wide port configuration element 106 may receive directions to reconfigure wide port 150 from the reconfiguration controller 110 of the SAS expander 108. As used herein, “reconfiguration” within the SAS device 102 may refer to either active reconfiguration to logically group more or less PHYs (links) into a wide port, or simple administrative functions to log or record changes in present operation of a wide port effectuated by a SAS expander. “Reconfiguration” as used in reference to element 110 of SAS expander 108 refers to active reconfiguration of one or more of the PHYs comprising a wide port such as by enabling or disabling one or more of the PHYs of a wide port or may refer to communication to another SAS device 102 of the under-utilization or over-utilization of available bandwidth of a wide port.

As noted above, it is often difficult to predict in advance the actual performance requirements and bandwidth utilization of a particular SAS wide port. Further, the performance requirements and bandwidth utilization may change dramatically over time depending on a number of factors associated with utilization of the SAS domain 100. Therefore, in accordance with features and aspects hereof, any SAS device such as enhanced SAS expander 108 may include performance monitor 112 for monitoring actual usage of links in wide port 150. Further, reconfiguration controller 110 may then automatically reconfigure operation links of the wide port to adapt to changing requirements or bandwidth utilization patterns of wide port 150 and SAS domain 100.

Substantially in parallel with normal functioning of SAS device 102 and SAS expander 108, performance monitor 112 may measure various performance aspects of wide port 150 and thereby determine statistical information regarding performance and utilization of the wide port 150. In particular, performance monitor 112 may be adapted to monitor bandwidth utilization of the wide port 150. Where a determination is made that the available bandwidth is being over-utilized, reconfiguration controller 110 may be responsive to add additional links to the plurality of links that comprise wide port 150. Conversely, where performance monitor 112 determines that the available bandwidth of wide port 150 is presently being under-utilized, reconfiguration controller 110 may disable one or more links comprising wide port 150. By so disabling a link, power consumption within the SAS expander may be reduced. In general, transceiver components within a SAS expander used for transceiving information on an associated link consume a significant portion of the power of the SAS expander. Disabling the link may reduce or eliminate the power consumption inherent in the transceiver component associated with the disabled link.

Reconfiguration controller 110 may automatically perform the desired reconfiguration within the same device that performs the monitoring function (e.g., within SAS expander 108 where performance monitor 112 also performs the desired monitoring function). Alternatively, reconfiguration controller 110 may be co-resident and co-operable with associated wide port configuration elements 106 within an associated SAS device 102. Thus, reconfiguration controller 110 may merely communicate the desirability for reconfiguration to the wide port configuration element 106 of the SAS device 102 and thus enable the SAS device 102 to perform desired reconfiguration. As noted above, the reconfiguration performed by element 106 in device 102 may include receiving and logging the information suggesting a need for reconfiguration. The information may then be presented to an administrative user for further analysis and remedial action if desired. Further, as above for the reconfiguration element 110 within expander 108, reconfiguration element 106 in device 102 may actively enable/disable PHYs of the wide port to enhance performance and/or to reduce energy consumption.

The enabling or disabling of links configured in a wide port, as discussed further herein below, may preferably be performed locally within the SAS expander in which the performance monitor is co-operable. Reconfiguring the wide port to permanently include or exclude particular links may preferably be performed within a SAS initiator or provided to a system designer that initially configures the SAS wide port 150. Even where reconfiguration controller 110 of SAS expander 108 automatically performs enabling and disabling of links comprising wide port 150, reconfiguration controller 110 may preferably notify wide port configuration element 106 of the associated SAS device 102 to permit synchronized tracking of the current configuration and utilization of wide port 150.

Those of ordinary skill in the art will readily recognize that the reconfiguration controller 110 and performance monitor 112 may both be implemented within a SAS expander, both within a SAS initiator, or distributed between an initiator and an associated expander. Still further, the features and aspects hereof may be operable to monitor performance of a wide port coupling two SAS expanders. One SAS expander in a SAS domain may be designated a primary or master SAS expander. The master SAS expander may then acquire statistical performance information from other SAS expanders regarding associated wide ports. The master SAS expander may then perform desired reconfiguration and/or instruct other SAS expanders associated with the monitored wide ports to perform desired reconfiguration.

In the best known mode of implementing features and aspects hereof, the performance monitor 112 and associated reconfiguration controller 110 are preferably implemented within the SAS expander to reduce processing burdens imposed on any SAS initiator in the domain. The general or special purpose processing features within the SAS expander may typically have excess unused processing capacity as compared to similar processing features within a SAS initiator device. However, such features may be equivalently implemented within any appropriate SAS device for a particular application.

Those of ordinary skill in the art will readily recognize numerous additional elements that may be implemented within a fully functional SAS device 102 and SAS expander 108. The diagram of FIG. 1 is therefore intended merely as exemplary of functional aspects associated with features and aspects hereof and is simplified for brevity of this discussion.

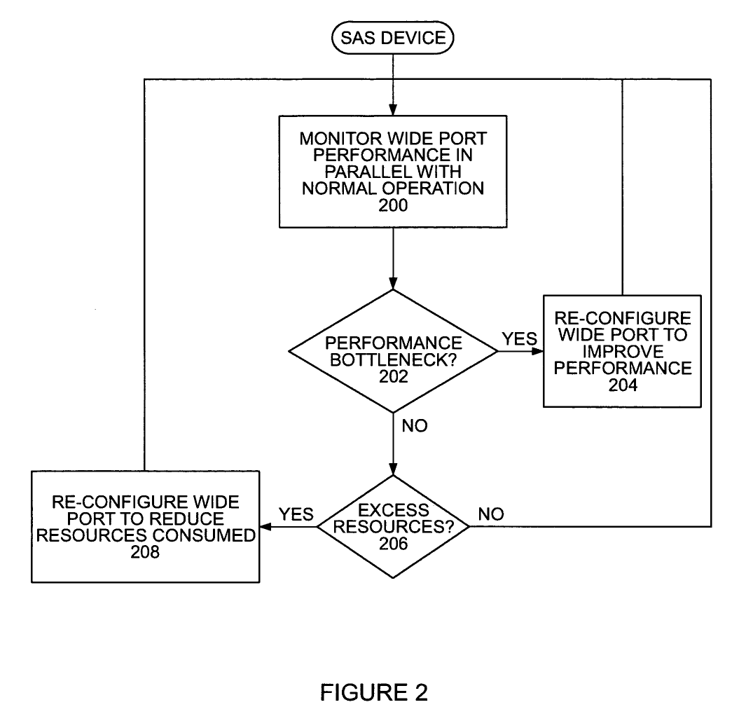

FIG. 2 is a flowchart describing a method in accordance with features and aspects hereof to permit monitoring of wide port performance by a SAS device and to effectuate reconfiguration to improve performance thereof and/or to reduce resource consumption thereby. As noted above, the method of FIG. 2 may be operable within any SAS device configured to utilize a wide port in its communication path to another SAS device. For example, a SAS initiator or SAS expander device may perform the monitoring and reconfiguration functions as a feature within the SAS initiator control logic. In a preferred embodiment, the method of FIG. 2 may be implemented within a SAS expander such that the SAS expander monitors performance of one or more wide ports associated with one or more other SAS devices. The enhanced SAS expander utilizing the method of FIG. 2 may then reconfigure aspects of the wide port to improve performance and/or reduce resource consumption. Reconfiguration as discussed further herein below may be automated within the operation of the SAS device or may be performed in cooperation with another SAS device such as a SAS initiator or another SAS expander adapted for reconfiguring one or more wide ports in a SAS domain. Thus one SAS expander may be designated a master expander in a SAS domain and may gather monitored performance data of wide ports in the domain from other expanders and devices in the domain. The master expander may then perform the reconfiguration steps described herein by issuing appropriate commands and directives to other expanders and devices in the domain.

Element 200 represents processing within the SAS device to monitor wide port performance in parallel with normal operation of the SAS device performing the method of FIG. 2. Normal operation entails any processing associated with exchange of information over the wide port being monitored by operation of element 200. As the wide port is utilized in normal operation information exchanges, element 200 may accumulate statistical information regarding the utilization of the wide port. In particular, the monitoring may evaluate the bandwidth utilization of the wide port as information is exchanged between the device operating the method of FIG. 2 and another device coupled through the wide port being monitored.

Element 202 then determines from the statistical information gathered by operation of element 200 whether the wide port's current bandwidth utilization represents a performance bottleneck. If the statistical information gathered indicates that the wide port is over-utilized (e.g., above a predetermined threshold value), processing continues with the element 204 to effectuate reconfiguration of the wide port to improve performance. For example, element 204 may effectuate the addition of further links to the complement of multiple links presently comprising the wide port thus improving performance by adding available bandwidth to the wide port to relieve the performance bottleneck.

If element 202 determines that the wide port is not presently over-utilized (e.g., not a performance bottleneck) then element 206 is next operable to determine whether the wide port is under-utilized. For example if the wide port currently comprises multiple links and the bandwidth utilization is notably low (e.g., below a predetermined threshold) it may be beneficial to reduce the number of links presently comprising the wide port. Since the wide port is not fully utilizing the present complement of parallel links it may be optimal for the SAS device to utilize some of the links for other purposes such as connecting to other devices in the SAS domain. If element 206 determines that the wide port is presently under-utilized, processing continues with element 208 to effectuate reconfiguration of the wide port to reduce the unused resource consumption. In other words, element 208 represents processing to, for example, disable some of the links presently comprising the wide port.

The reconfigured, disabled links may be disabled so as to reduce power consumption within the SAS device. As used herein, “disabling” of a link of a SAS device may include turning off the transceiver component of the corresponding link to reduce the power consumption of that presently under-utilized link. Disabling of a link may include other operations unique to a particular transceiver in a particular link of a particular SAS device as a matter of design choice well known to those of ordinary skill and the art. Where in a particular application the PHYs that comprise a wide port may be dynamically reconfigured so as to permanently add or remove a PHY to or from the wide port, the wide port may be permanently reconfigured to better allocate the PHYs of an expander to other devices in the domain.

If element 206 determines that the wide port is not currently under-utilized (e.g., no excess unused resources are presently being consumed) or if element 204 or element 208 effectuate reconfiguration of the wide port, processing continues by looping back to element 200 to continue monitoring of the wide port. Thus the method of FIG. 2 may be continuously operable within the SAS device substantially in parallel with normal operation of the wide port to be monitored. Further, those of ordinary skill in the art will readily recognize that the method of FIG. 2 may be replicated for each wide port configured within a SAS device or may be otherwise operable to continuously monitor multiple wide ports. Still further, those of ordinary skill in the art will readily recognize that predetermined threshold values may be configured for determining when a wide port has been over-utilized as tested by element 202 or under-utilized as tested by element 206.

As noted above, the method of FIG. 2 may be operable within any SAS device of a SAS domain. For example, a SAS initiator may monitor a wide port that it has configured to determine whether reconfiguration of the wide port is preferred. Since most SAS initiator devices are responsible for significant other processing (e.g., other processing within an associated host system) the best presently known mode for implementing features and aspects hereof provide for implementing the method of FIG. 2 within a SAS expander. The SAS expander may perform monitoring substantially in parallel with normal operation of a wide port without burdening a SAS initiator or its associated host system with the monitoring requirements and associated computations. Most SAS expanders include sufficient processing capabilities to permit the desired monitoring and reconfiguration to be performed locally without requiring significant intervention from SAS initiators or host devices coupled thereto. Still further, one SAS expander in a SAS domain may be designated a master expander and may gather performance information from other devices in the domain regarding wide ports anywhere in the SAS domain. The master expander may then determine appropriate reconfiguration of the PHYs that comprise each of the monitored wide ports. The master expander may then direct the other devices to enable or disable PHYs of the wide ports to better utilize resources of the wide ports. Thus the method of FIG. 2 may be, in essence, distributed over multiple devices in the SAS domain.

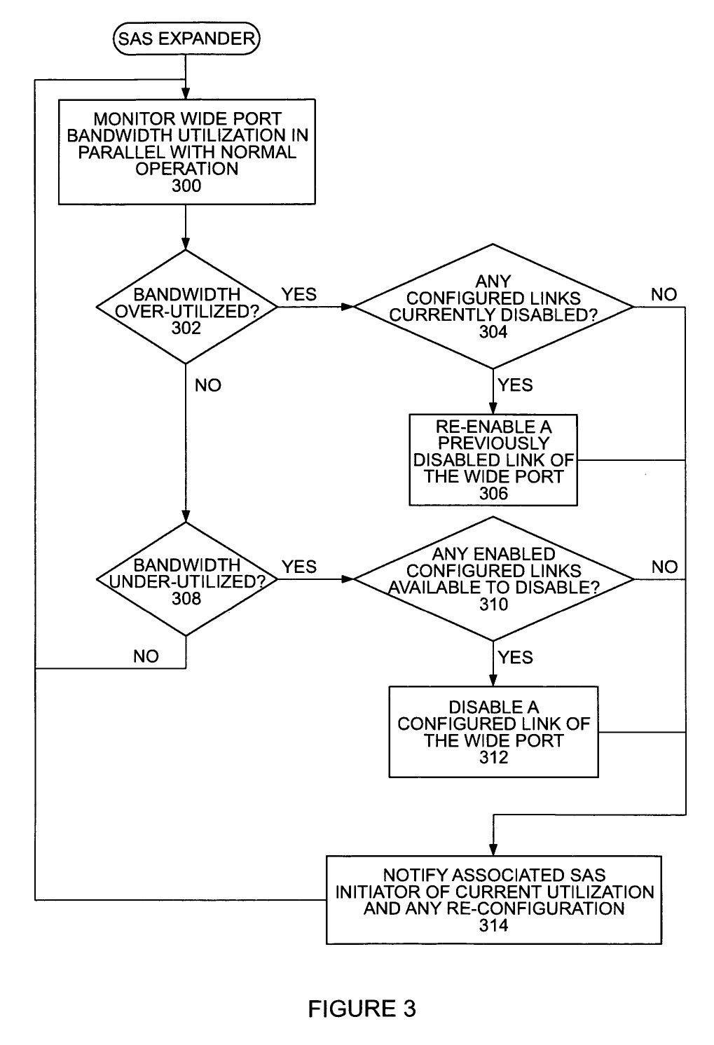

FIG. 3 is a flowchart describing a method in accordance with features and aspects hereof operable within an enhanced SAS expander to monitor performance of a wide port associated with the SAS expander and to effectuate reconfiguration thereof. Element 300 is operable as discussed above with respect to element 200 of FIG. 2 to monitor the wide port bandwidth utilization (or other performance attributes) in parallel with normal operation of the wide port. As above with respect to element 200 of FIG. 2, element 300 represents monitoring processing performed substantially in parallel with normal exchange of information over the wide port being monitored. Other processing of the SAS expander (not shown) performs such normal exchanges of information over the wide port. The monitoring aspect of element 300 of FIG. 3 therefore represents the additional processing to accumulate statistical information indicative of the performance of the wide port being monitored. Monitoring may proceed through a predetermined period of time to accumulate useful, statistically meaningful information regarding performance of the wide port. Periodically, upon accumulation of sufficient, statistically meaningful performance information, elements 302 through 314 are operable to analyze the accumulated statistical performance information to determine whether any reconfiguration of the wide port is desirable.

Element 302 is operable to determine whether the available bandwidth of the currently configured wide port is over-utilized. If so, element 304 is operable to determine whether any of the links that comprise the wide port that are presently disabled. As discussed further herein below, individual links that comprise a wide port may be disabled to conserve power or other resources of the wide port in the SAS expander when the wide port is under-utilized. If element 304 determines that all originally configured links of the wide port are presently enabled, no automated reconfiguration is possible for the SAS expander and processing continues with element 314 to simply notify an appropriate associated SAS initiator of the current over-utilization of the wide port available bandwidth. The SAS initiator may inform an appropriate system administrator or designer of the monitored performance information. The SAS initiator or system designer that originally configured the wide port may then take appropriate remedial action if possible.

If element 304 determines that some of the originally configured links of the wide port were previously disabled, element 306 is operable to re-enable one or more previously disabled links originally configured in the wide port. Thus, the SAS expander enhanced to perform the method of FIG. 3 may reconfigure the SAS wide port by re-enabling previously disabled links of the wide port. As above, processing then continues with element 314 to notify the associated SAS initiator of the current level of utilization of the wide port and to inform the associated SAS initiator of the automatic reconfiguration performed by the enhanced SAS expander.

If element 302 determined that the wide port available bandwidth is not presently over-utilized based on analysis of the statistical information gathered by element 300, element 308 is next operable to determine whether the statistical information indicates that the available bandwidth of the wide port is presently under-utilized. If not, processing continues looping back to element 300 to continue monitoring operation of the wide port and to periodically analyze the gathered statistical information to determine whether any automated reconfiguration would be useful.

If element 308 determines that the present bandwidth utilization represents under-utilization of the wide port, element 310 is next operable to determine whether any of the presently enabled links of the wide port may be disabled. If not, processing continues as noted above with element 314 to simply notify an appropriate, associated SAS initiator regarding the current level of bandwidth utilization of the wide port. If element 310 determines that some presently enabled link of the wide port may be disabled, element 312 is next operable to disable one or more of the links presently enabled for operation in the wide port. As noted above, disabling of a link may entail turning off the associated transceiver circuit that typically consumes a significant portion of the power allocated to a particular link. Thus, disabling a link of the wide port may conserve power resources within the SAS expander while not significantly impacting performance of the presently operating wide port. Having so disabled one or more links of the wide port, processing continues with element 314 to notify the appropriate associated SAS initiator regarding the current level of bandwidth utilization in the wide port and to inform the SAS initiator of the automated reconfiguration performed by the SAS expander in disabling one or more links of the wide port.

Following processing of element 314 to notify an associated SAS initiator of any changes, processing continues looping back to element 300 as discussed above to gather statistical performance information for another period of time.

Those of ordinary skill in the art will readily recognize that elements 302 and 308 determining over-utilization or under-utilization of available bandwidth of a wide port may be performed by comparison against predetermined threshold values appropriate for the particular SAS domain application. Still further, those of ordinary skill in the art will readily recognize that other performance criteria may be similarly monitored to effectuate automated reconfiguration of the SAS wide port by operation of the enhanced SAS expander or any other suitable SAS device embodying the method of FIG. 3. Still further, numerous equivalent method steps will be readily apparent to those of ordinary skill in the art to provide the desired automated monitoring and reconfiguration of a SAS wide port by local processing within an enhanced SAS expander or other SAS device.

By notifying an associated SAS initiator regarding the current level of utilization and any associated automated reconfiguration performed by the SAS expander, the SAS initiator may perform further reconfiguration. For example, where a enhanced SAS expander informs an associated SAS initiator that one or more of the presently configured links comprising a wide port have been disabled due to under-utilization, the SAS initiator or a system designer informed of the condition by the SAS initiator may choose to permanently reconfigure the affected wide port to eliminate the disabled link and then utilize the disabled link for another communication path between the initiator and some other SAS device. The self monitoring and reconfiguration features of the enhanced SAS expander therefore permit flexible reconfiguration within an associated SAS initiator, within a SAS expander or by a system administrator or designer in response to monitored performance information.

The notification information transferred from the enhanced SAS expander to an associated SAS initiator may utilize any of several well-known protocols and communications standards. For example, the message may be transferred utilizing standard SMP or SSP protocols within the SAS architecture. The SAS initiator may poll the enhanced SAS expander for such bandwidth utilization and reconfiguration information or the SAS initiator may be configured to operate as a target device in response to initiated communications from the SAS expander regarding bandwidth utilization and automated reconfiguration associated therewith.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

What is claimed is:

1. A method operable in a SAS domain for reconfiguring a SAS wide port of a SAS expander, the method comprising:
monitoring performance of an operating wide port-associated with the SAS expander;
effecting reconfiguration of the operating wide port to improve performance thereof.

2. The method of claim 1
wherein the step of monitoring further comprises monitoring bandwidth utilization, and
wherein the step of effecting reconfiguration further comprises informing a SAS device coupled to the SAS expander of bandwidth over-utilization of the wide port to cause the SAS device to reconfigure the wide port to add one or more additional links to the wide port.

3. The method of claim 2 wherein the SAS device is another SAS expander.

4. The system of claim 2 wherein the SAS device is a SAS initiator.

5. The method of claim 1
wherein the step of monitoring further comprises monitoring bandwidth utilization, and
wherein the step of effecting reconfiguration further comprises disabling a link associated with the wide port in response to determining that the available bandwidth of the wide port is under-utilized.

6. The method of claim 5
wherein the step of effecting reconfiguration further comprises re-enabling a previously disabled link associated with the wide port in response to determining that the available bandwidth of the wide port is over-utilized.

7. A system comprising:
a SAS device; and
a SAS expander coupled to the SAS device wherein the SAS expander is coupled to the SAS device by a wide port and wherein the SAS expander further comprises:
a performance monitor adapted to monitor performance of the wide port during operation thereof, and
a reconfiguration controller coupled to the performance monitor adapted to effect reconfiguration of the wide port based upon monitored performance of the wide port.

8. The system of claim 7 wherein the performance monitor is further adapted to monitor bandwidth utilization of the operating wide port.

9. The system of claim 8 wherein the reconfiguration controller is adapted to inform the SAS device of a bandwidth over-utilization condition of the operating wide port as sensed by the performance monitor.

10. The system of claim 7 wherein the reconfiguration controller is adapted to disable a link of the wide port in response to detection of a bandwidth under-utilization condition of the operating wide port sensed by the performance monitor.

11. The system of claim 10 wherein the reconfiguration controller is further adapted to re-enable a previously disabled link of the wide port in response to detection of a bandwidth over-utilization condition of the operating wide port sensed by the performance monitor.

12. The system of claim 7 wherein the SAS device is another SAS expander.

13. The system of claim 7 wherein the SAS device is a SAS initiator.

14. In a SAS domain having a SAS expander with an associated SAS wide port, apparatus for reconfiguring the wide port comprising:
monitoring means for monitoring performance of an operating wide port associated with the SAS expander;
reconfiguration means, communicatively coupled to the monitoring means, for effecting reconfiguration of the operating wide port to improve performance thereof.

15. The apparatus of claim 14
wherein the monitoring means further comprises means for monitoring bandwidth utilization, and
wherein the reconfiguration means further comprises means for informing a SAS initiator of bandwidth over-utilization of the wide port to cause the SAS initiator to reconfigure the wide port to add one or more additional links to the wide port.

16. The apparatus of claim 15 wherein the SAS device is another SAS expander.

17. The apparatus of claim 15 wherein the SAS device is a SAS initiator.

18. The apparatus of claim 14
wherein the monitoring means further comprises means for monitoring bandwidth utilization, and
wherein the reconfiguration means further comprises means for disabling a link associated with the wide port in response to the monitoring means determining that the available bandwidth of the wide port is under-utilized.

19. The apparatus of claim 18
wherein the reconfiguration means further comprises means for re-enabling a previously disabled link associated with the wide port in response to the monitoring means determining that the available bandwidth of the wide port is over-utilized.
